(19) United States
(12) Patent Application Publication
(10) Pub. No.: US 2015/0103343 A1
(43) Pub. Date: Apr. 16, 2015

(54) TUNABLE OPTICAL FILTER

(71) Applicant: ISIS INNOVATION LIMITED, Oxford, Oxfordshire (GB)

(72) Inventors: Jason Michael Smith, Oxford (GB); Claire Vallance, Oxford (GB)

(73) Assignee: ISIS INNOVATION LIMITED, Oxford, Oxfordshire (GB)

(21) Appl. No.: 14/398,755

(22) PCT Filed: May 3, 2013
(86) PCT No.: PCT/GB2013/051167

§ 371 Date: Nov. 4, 2014

(30) Foreign Application Priority Data
May 4, 2012 (GB) 1207880.4

(51) Int. Cl. G01J 3/12; G01N 21/25; G01J 3/02; G02B 26/00; G02B 5/20

(52) U.S. Cl. CPC G01J 3/12; G02B 26/001; G02B 5/201; G01J 3/0205; G01N 21/25; G02B 5/10
USPC 356/326; 359/578; 359/579

(57) ABSTRACT

An apparatus for performing spectroscopy incorporates, between an EM source and a detector, an optical filter comprising a pair of mirrors opposed along the optical axis and shaped to provide an optical cavity with stable resonance and having a cavity length of at most 50 μm and a mode at a wavelength within said band of wavelengths for bandpass filtering EM radiation passing therethrough. The actuator system is arranged to move the mirrors relative to each other along the length of the optical cavity for tuning the wavelength of said mode.

The present invention relates generally to spectroscopy and in particular to providing tunable filtering of electromagnetic (EM) radiation in an apparatus for performing spectroscopy.

A tunable EM radiation filter is a device with optical transmittance that is wavelength dependent, and for which the wavelength dependence can be modified by some external control.

In the most common examples, the filter will transmit EM radiation that falls within a particular wavelength range, the centre wavelength of which can be varied, and block incident EM radiation of wavelengths outside this range. For most applications a narrow transmission band, high peak transmission, effective blocking of stray EM radiation, wide tuning range, and speed of operation are the most important characteristics.

In spectroscopy applications, tunable filters are commonly used as ‘monochromators’. This implies a narrow transmission band in order to maximise the spectral selectivity, and therefore the spectral detail obtained if wavelength scanning is performed. Spectral filters generally only permit discrimination of a single wavelength at a time, and so spectroscopy often requires some scanning of the wavelength, perhaps by rotating a grating, changing the period of a grating in an acousto-optic modulator or a fibre Bragg grating, or by changing the plate separation in a Fabry Perot etalon.

Most common uses of tunable EM radiation filters are therefore in ultra-high resolution spectroscopy where multi-channel detection approaches are either unavailable or prohibitively expensive, or in imaging where an array detector is required to record spatial information. For spectroscopic applications a wide tuning range and narrow transmission band are particularly important to maximise the spectroscopic information that can be recorded.

One known type of EM radiation filter is a grating-based monochromator, but these tend only to be used in laboratory based spectroscopy applications as they are bulky, relatively low resolution, and slow to tune.

Tuneable filters based on acousto-optic modulators offer spectral resolution of the order of 1 nm, tuning ranges of the order of λ/3, and MHz modulation rates. They are single channel devices and can not easily be arrayed for imaging purposes.

Another known type of EM radiation filter is a Fabry Perot etalon with both planar and concave mirrors. Such devices are used for various applications. They are tunable over the Free Spectral Range which is generally a fixed multiple of the line width (known as the Finesse). For a balanced Fabry Perot with mirrors of equal (and high) reflectivity R the Finesse F is given by

$$F = \frac{π}{1 - R} \qquad ( 1 )$$

Due to the difficulty and cost of fabricating ultra-smooth mirrors with small radius of curvature, commercial concave mirror Fabry Perot etalons typically have cavity lengths of the order of 1 mm or more resulting in a Free Spectral Range (i.e., tuning range) of <0.2 nm. Over this range they can deliver unsurpassed resolution. Recently a Fabry Perot resonator with a tuning range of about 30 nm and a finesse of 50,000 has been reported in Reference [5].

According to an aspect of the present invention, there is provided a method of filtering EM radiation in an apparatus for performing spectroscopy that comprises, arranged along an optical axis:

an EM source arranged to generate EM radiation having a band of wavelengths for illuminating a sample;

a sample holder arranged to hold the sample; and

a detector for detecting EM radiation transmitted through the sample,

the method comprising:

providing, within the apparatus between the EM source and the detector, an optical filter comprising a pair of mirrors opposed along the optical axis and shaped to provide an optical cavity with stable resonance and having a cavity length of at most 50 μm and a mode at a wavelength within said band of wavelengths for bandpass filtering EM radiation passing therethrough, and

further providing an actuator system arranged to move the mirrors relative to each other along the length of the optical cavity for tuning the wavelength of said mode.

The present invention uses an optical filter based on a micrometer scale optical microcavity, that can be employed in a variety of spectroscopic applications.

The use of the microcavity not only reduces the mode volume, but increases the Free Spectral Range (FSR), thereby facilitating filtering by a single mode of the optical cavity. Accordingly, this form of optical filter offers a relatively narrow transmission band. Furthermore, this optical filter is a simple, inexpensive device.

Furthermore, the actuator system provides tuning of mode and hence the transmission band the over a wide wavelength range. The actuation system may be any system that is capable of moving the mirrors relative to each other, for example a piezoelectric actuator.

The optical filter may be applied to range of different types of spectroscopy, for example IR spectroscopy, including rovibrational spectroscopy of gases and fluids and gas and liquid phase sensing. Taking rovibrational spectroscopy as an example to illustrate the benefits of the present invention, typical current apparatuses require either an expensive tunable laser or an expensive spectrometer such as a Fourier Transform Infrared (FTIR) spectrometer. In contrast, use of the optical filter in accordance with the present invention removes the need for either of these devices, and instead provides spectral discrimination by the much simpler and cheaper optical filter.

Another advantage of the present invention is that the optical filter is straightforward to fabricate into an array. In that case, there may provided an array of said optical filters within the apparatus between the EM source and the detector. Such an array may be used in a range of applications, including spatial and spectral imaging purposes.

The optical cavities may advantageously be designed to improve their spectral characteristics.

A number of configurations of the mirrors may be used to provide the optical cavity with a stable resonance for modes confined perpendicular to the optical axis between the mirrors. To provide such confinement, typically, at least one of the mirrors is concave. Stable resonant modes produced in this way are robust to misalignment of the two mirrors and to the angle of incidence of illuminating radiation. This allows the optical filter to be designed to provide good mode control, good stability, good field of view (low sensitivity to the angle of angle of incidence of illuminating radiation), and a wide tuning range.

The cavity length may be reduced, for example to be at most 30 μm, preferably at most 10 μm to increase the FSR which increases their tuning range and increases the spectral separation of the modes confined perpendicular to the optical axis which aids in producing single mode transmission, and also reduces the mode volume.

Minimisation of the radius of curvature increases the spectral separation of the modes confined perpendicular to the optical axis which aids in producing single mode transmission, and also reduces the mode volume. In that case, the concave mirror preferably has a relatively low radius of curvature, for example at most 50 μm, preferably at most 30 μm or 10 μm or 3 μm.

Advantageously, one of the mirrors is concave and the other one of the mirrors is planar. This avoids the need to provide alignment of the mirrors perpendicular to the optical axis between the mirrors.

Concave mirrors of small size may be formed by focussed ion beam milling.

Advantageously, the reflectivity of the mirrors is maximised in order to maximise the quality factor Q. This minimises the width of the modes and thereby provides increased sensitivity. Advantageously, the mirrors have a root-mean-square roughness of at most 1 nm, and/or a reflectance of at least 99%, preferably at least 99.5%. Advantageously to provide high reflectivity, the mirrors may be Bragg reflectors.

According to a further aspect of the present invention, there is provided an apparatus for performing spectroscopy in which a similar tunable optical filter is provided.

To allow better understanding, an embodiment of the present invention will now be described by way of non-limitative example with reference to the accompanying drawings, in which:

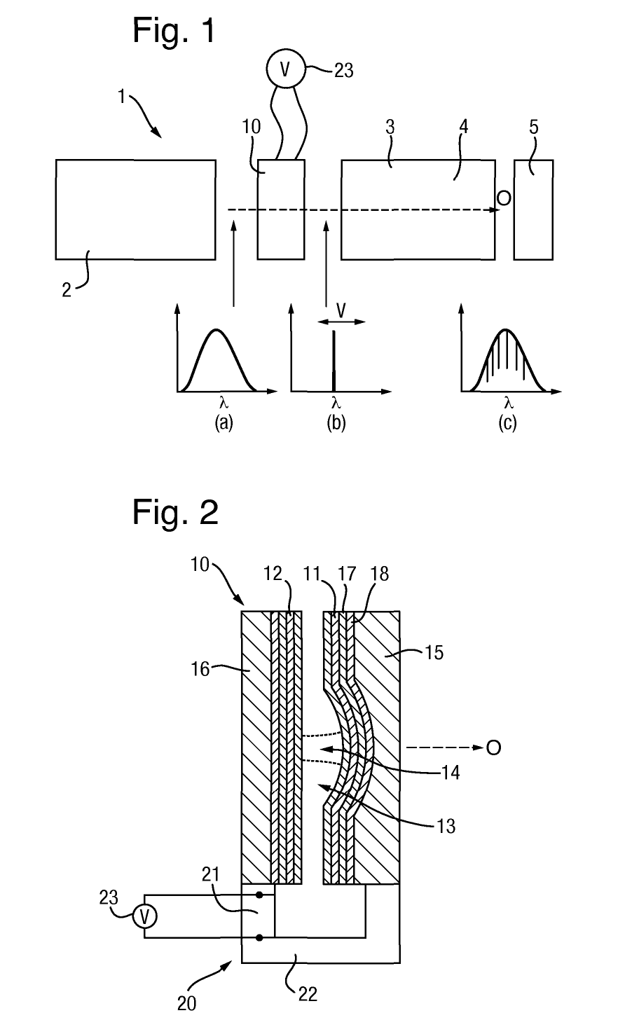

FIG. 1 is a diagram of an apparatus for performing spectroscopy, including intensity spectrums at three points along the optical axis;

FIG. 2 is a side view of a cavity arrangement;

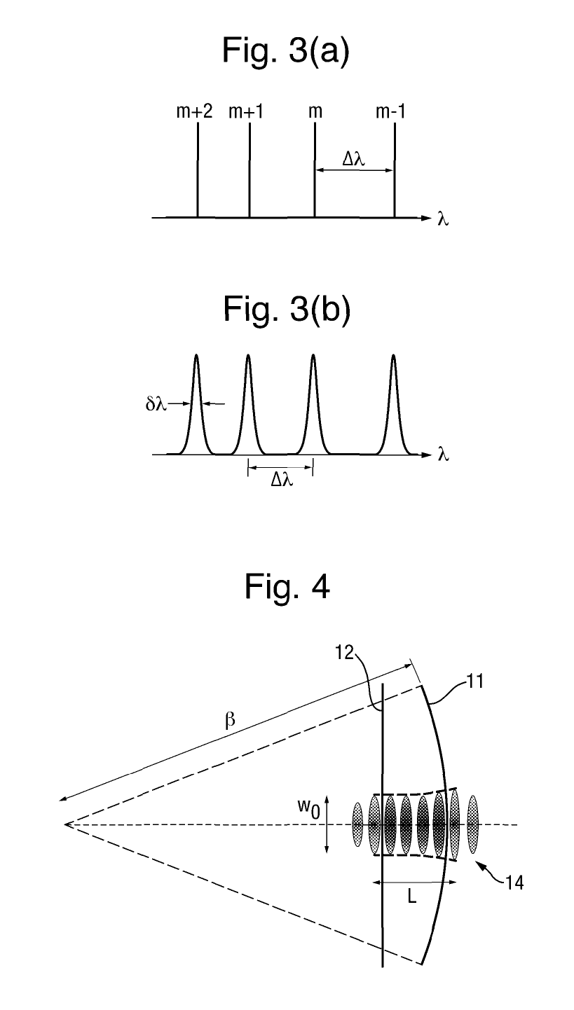

FIGS. 3(a) and 3(b) are plots of an intensity spectrum of an optical cavity with no losses and losses, respectively, illustrating the mode structure;

FIG. 4 is a side view of the optical cavity illustrating dimensional quantities;

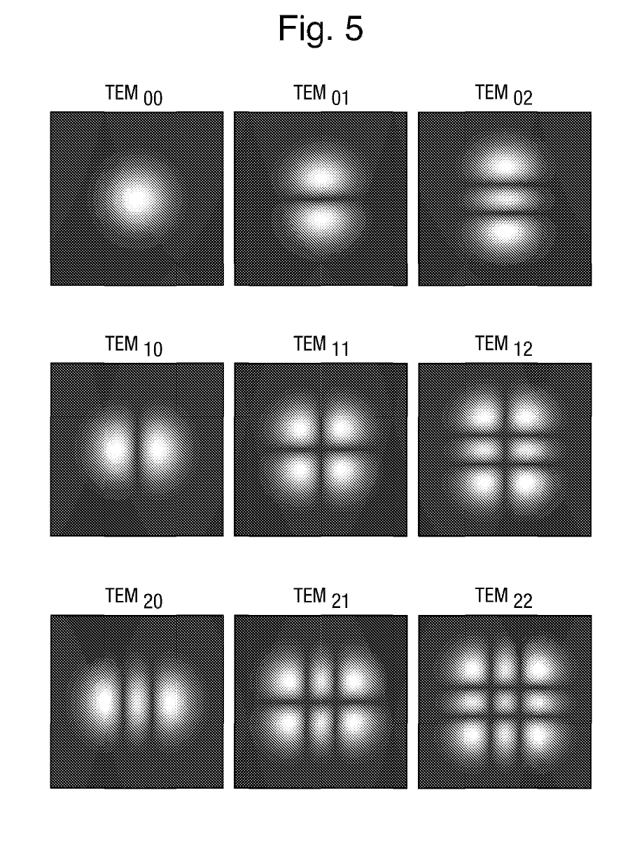

FIG. 5 is a set of plots of spatial distributions of the first nine Hermite-Gauss TEMₘₙ cavity modes perpendicular to the optical axis;

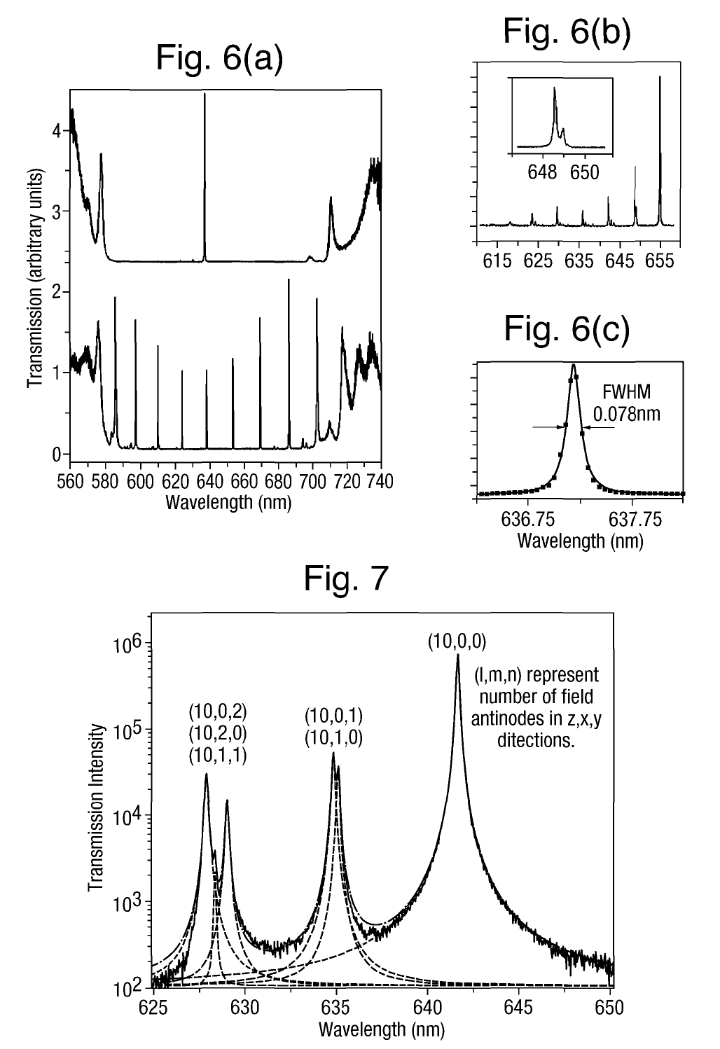

FIGS. 6(a) to (c) are measured transmission spectra of an optical cavity;

FIG. 7 is a graph of a transmission spectrum for an optical cavity used as an optical filter;

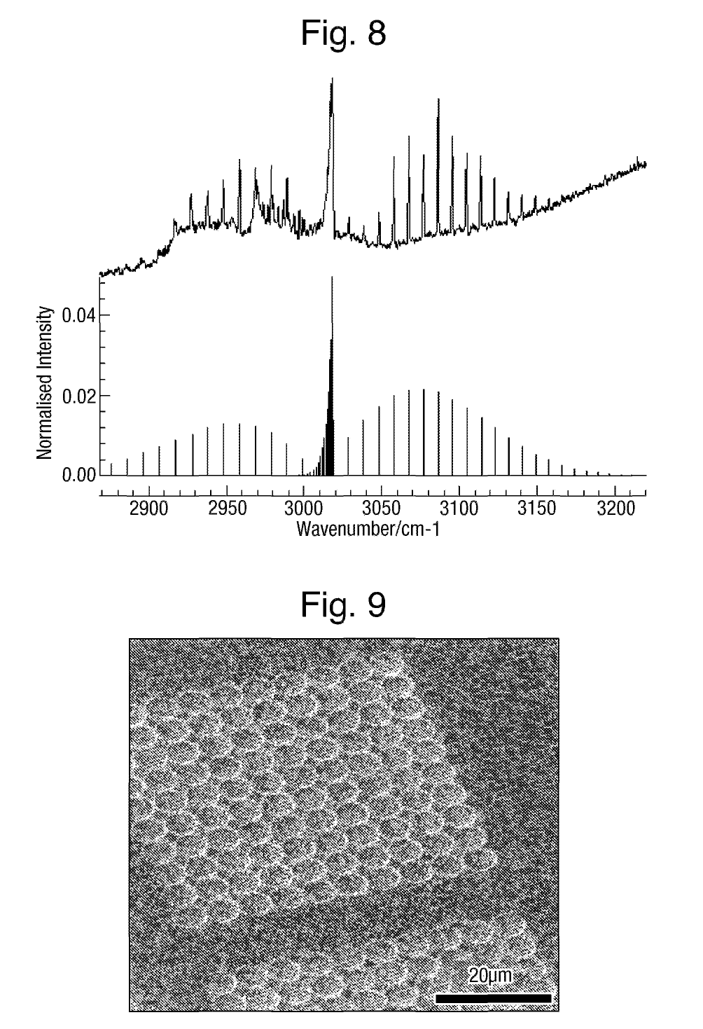

FIG. 8 is a graph of the rovibrational spectrum of methane; and

FIG. 9 is an electron micrograph of an array of concave features fabricated into a substrate by ion beam milling and suitable for mirror coating.

The present invention is applied generally to EM radiation including in any combination: ultraviolet light (which may be defined herein as having wavelengths in the range from 10 nm to 380 nm); visible light (which may be defined herein as having wavelengths in the range from 380 nm to 740 nm); infrared light (which may be defined herein as having wavelengths in the range from 740 nm to 300 μm); and/or other wavelengths. Herein, the terms ‘optical’ and ‘optics’ are used to refer generally to the EM radiation to which the invention is applied.

An apparatus 1 for performing spectroscopy is shown in FIG. 1 and comprises with the following components arranged along an optical axis O. Herein, the terms ‘optical’ and ‘optics’ are used to refer generally to EM radiation including visible EM radiation and EM radiation outside the visible range, for example infrared (IR) radiation.

An EM source 2 generates EM radiation having a band of wavelengths for illuminating a sample. The intensity spectrum of the EM radiation is shown in the graph (a) illustrating the relatively broad width of the band of wavelengths. The EM radiation is emitted along the optical axis O. The EM source 2 may be of any type, including a laser or a light emitting diode. The EM source 2 may also be an ambient source, that is an optical arrangement arranged to direct ambient light into the apparatus 1.

A sample holder 3 arranged to hold a sample 4 is disposed along the optical axis O for the sample to receive EM radiation emitted by the EM source 2. In many applications, the sample 4 may be a gas or fluid. The sample 4 may be a sample that is collected and inserted into the apparatus 1, in which case the sample 4 is contained within the sample holder 3. Alternatively, the sample 4 may be an ambient gas, such as air, in which the apparatus 1 is disposed. In this case, the sample holder 3 defines a cavity or space which provides access allowing entry of a portion of the ambient gas as the sample 4. In other applications, the sample 4 may be a solid, in which case the sample holder 3 may be a support that physically supports the sample 4.

The sample 4 interacts with the EM radiation incident on it, for example by absorbing EM radiation at particular wavelengths. To illustrate this, the graph (c) shows an example of the intensity spectrum of the EM radiation generated by the EM source 2 with absorption at a set of discrete wavelengths within the band.

A detector 5 for detecting EM radiation is disposed along the optical axis O beyond the sample holder so that it receives and detects EM radiation that is transmitted through the sample 4 held by the sample holder 3. The detector 5 may be of any suitable type, for example a CMOS (complimentary metal-oxide-semiconductor) detector.

The apparatus 1 further comprises a cavity arrangement 10 disposed along the optical axis between the EM source 4 and sample holder 2. The cavity arrangement 10 is shown in FIG. 2 and arranged as follows.

The cavity arrangement 10 is an open-access optical microcavity that comprises a pair of mirrors 11 and 12 opposing each other along the optical axis O. The microcavity is referred to as ‘open access’ because the mirrors 11 and 12 are open at the sides, transverse to the optical axis, thereby providing open access to the space therebetween.

The space between the mirrors 11 and 12 may be free space (vacuum), gas (e.g. air or other gas) or liquid.

The mirrors 11 and 12 are formed on substrates 15 and 16 and are shaped to provide an optical cavity 13 therebetween. An optical cavity confines EM radiation, such that the electromagnetic field has a stable resonance and forms standing waves of discrete frequencies and spatial distributions. Each standing wave state is known as a ‘mode’ of the EM field. For each mode, constructive interference of the electromagnetic waves occurs when a single ‘round trip’ of the cavity is described. The mirrors 11 and 12 are shaped so that the optical cavity 13 has stable resonance for at least one mode 14 that is confined in three dimensions, that is along and perpendicular to the optical axis O by reflection at the mirrors 11 and 12, as shown schematically in FIG. 2 (and also FIG. 4).

The cavity length L of the optical cavity 13 is the distance between the mirrors 11 and 12 including the field penetration into the mirrors 11 and 12.

There will now be given a general description of optical cavities that applies to the optical cavity 13.

By way of illustration for the confinement in the dimension along the optical axis O between the mirrors 11 and 12, the modes occur at wavelengths where the cavity length L (optical length of the cavity 13) is an integer number of half-wavelengths of the EM radiation, so that a round trip corresponds to an integer number of whole wavelengths. The criterion for a stable mode to exist in a planar Fabry Perot cavity may be written as

mλ=2L (1)

where m is an integer, λ is the optical wavelength inside the cavity and L is the cavity length. The mode wavelengths therefore form a series of discrete values corresponding to different values of m, as shown in FIG. 3(a) for the idealised cavity with no losses and in FIG. 3(b) for a real cavity with losses. In frequency space, the resulting cavity spectrum is often referred to as a ‘frequency comb’. For a given cavity, the lower limit of m may be 1, or the range of m values may be determined by the range of wavelength for which the mirrors 11 and 12 are reflective.

The Free Spectral Range (FSR) is the separation of the modes in wavelength space. For the illustrative one-dimensional example, the FSR is derived from equation 1 as

$$Δ λ = \frac{{λ}^{3}}{2 L} \qquad ( 2 )$$

Thus, the FSR can be seen to increase as the cavity length L is reduced. In general optical cavities with small cavity length L therefore contain fewer modes, spaced further apart in wavelength than the modes in optical cavities with large L.

The above text refers to a simple one-dimensional example, but the same principles apply for confinement in three dimensions in the optical cavity 13.

Equation 1 appears to imply that each individual mode (i.e. each value of m) has an exactly defined wavelength as shown in FIG. 3(a), but this simple picture is modified by leakage of EM radiation from the cavities, which results in each mode having a finite width δλ as shown in FIG. 3(b). This width δλ is related to the rate η at which photons leak from the cavity by the expression

$$δ λ = \frac{η {λ}^{3}}{2 π c} \qquad ( 3 )$$

where c is the speed of light in the cavity. The quality factor Q of a mode is defined as the ratio of the absolute resonant wavelength (the peak wavelength of the mode) and the mode width, that is

$$Q = \frac{λ}{δλ} = \frac{ω}{δ ω} \qquad ( 4 )$$

where ω is the angular frequency of the EM radiation in the cavity mode and δω is the mode width in angular frequency space. The quality factor Q is equivalent to the average number of optical cycles a photon undergoes within the cavity before it escapes. The quality factor may be attributed to the cavity itself, in which case it refers to the highest Q modes that the optical cavity supports.

Another important parameter for an optical cavity is the ‘mode volume’, which we label V. This represents the physical volume that is occupied by the majority of the energy in the optical mode. The energy density of an electromagnetic field is given by the product of the dielectric permittivity ∈ and the electric field intensity |E|². The mathematical definition of the mode volume is then the ratio of the total mode energy to the peak energy density, given by the equation:

$$V = \frac{\int \int {\int }_{all space} ɛ ( \vec{r} ) {\vert E ( \vec{r} ) \vert}^{2} d V}{{( ɛ {\vert E \vert}^{2} )}_{ma x}} \qquad ( 5 )$$

Conversely, if the mode volume is known, then the maximum root-mean-square (rms) electric field can be calculated for a specified number N of photons present, based on the total energy of a mode containing this number of photons

$$ξ = \sqrt{\frac{( N + \frac{1}{3} ) ℏ ω}{ɛ V}} . \qquad ( 6 )$$

In general terms, the smallest resonant cavity that can be achieved theoretically is a cube of side length λ/2 with perfectly reflecting walls (no field penetration), giving a mode volume of

$$V = \frac{{λ}^{3}}{8} .$$

The design parameters and general properties of the specific optical cavity 13 will now be described. In the following section there are described fabrication methods we use that allow us to combine mode volumes of order λ³ with values of the quality factor Q in excess of 10⁴.

In this example, three dimensional optical confinement is achieved by one mirror 11 being concave. The concave shape of the mirror 11 is spherical, but this is not essential and the mirror 12 could alternatively have another rotationally symmetric shape or a non-symmetric shape. The other mirror 12 is planar. An optical cavity 13 in which stable modes are formed is provided by a radius of curvature β of the concave mirror 11 being greater than the length L of the optical cavity 13, as illustrated in FIG. 4, as shown in FIG. 4.

As a result of the concave shape of the mirror 11, In addition to the longitudinal optical mode structure described above, the optical cavity 13 possess transverse electromagnetic modes with Hermite-Gauss mode structure as shown in FIG. 5. Each longitudinal mode has a fundamental transverse mode (TEM₀₀) and a family of transverse harmonics TEMₘₙ (integers m+n>0) at regular intervals on its short wavelength side. Some simple analytic equations can be used to describe this mode structure in the limit that β is significantly larger than L (known as the paraxial approximation).

The wavelength separation of the TEM modes with incrementing (m+n) is given by

$$Δ {λ}_{T} = \frac{{λ}^{2}}{2 π L} {cos}^{- 1} ( \sqrt{1 - \frac{L}{β}} ) \qquad ( 7 )$$

revealing that the mode separation increases as the radius of curvature decreases and as the cavity length decreases. For the TEM₀₀ modes the cross sectional intensity distribution is Gaussian in shape, and the beam waist is situated on the planar mirror.

The waist width w₀ (the minimum width of the optical mode being the width at the planar mirror 12) is given by

$${w}_{0}^{2} = \frac{λ L}{π} \sqrt{( \frac{β}{L} - 1 )} \qquad ( 8 )$$

whereby the mode volume is given by

$$V = \frac{π {w}_{0}^{3} L}{4} \qquad ( 9 )$$

Therefore, for example, a radius of curvature β=2λ combined with a cavity length L=λ would lead to a mode volume

$$V = \frac{{λ}^{3}}{4} .$$

The optical cavity has a cavity length of at most 50 μm, preferably at most 30 μm, more preferably at most 10 μm. Use of a microcavity with such a relatively short cavity length L increases the FSR, and also reduces the mode volume.

The concave mirror 11 has a radius of curvature of at most 50 μm, preferably at most 30 μm, more preferably at most 10 μm. Use of a microcavity with such a relatively short radius of curvature β increases the separation Δλ_{T} of the TEMₘₙ modes and may result in improved single mode transmission of EM radiation.

The mirrors 11 and 12 are formed to provide high reflectivity in order to maximise the quality factor Q. This minimises the width of the modes and thereby provides increased spectral resolution. Advantageously, the mirrors 11 and 12 have a reflectance of at least 99%, preferably at least 99.5%. To minimise losses, advantageously, the mirrors 11 and 12 have a root-mean-square roughness of at most 1 nm, and/or.

In particular the mirrors 11 and 12 may be Bragg reflectors. Such Bragg reflectors may comprise with multiple pairs of layers 17 and 18 alternating high and low refractive index dielectric material such as TiO₂/SiO₂, ZrO₂/SiO₂, Ta₂O₅/SiO₂, or ZnS/Al₂O₃. Each layer 17 and 18 is λ_{c}/4n in thickness, where λ_{c} is the selected ‘centre wavelength’ for highest reflectivity and n is the refractive index of the layer. These combinations provide high index contrast resulting in small field penetration depths into the mirror, and low optical absorption at most optical wavelengths. A chosen mirror design (materials used, number of pairs) will determine the maximum reflectivity and the range of wavelengths (the band width) over which the mirrors are effective. This band width can typically be of order 100 nm for a mirror operating in the visible region of the spectrum.

As an alternative in some applications, the mirrors 11 and 12 may be metal mirrors, although these tend to absorb a few percent of incident EM radiation at optical wavelengths and so are not suitable for the highest Q factor cavities.

A further limiting factor to the achievable reflectivity is scattering due to roughness of the coated surfaces. With a root-mean-square roughness σ the maximum reflectivity that can be achieved is

$${R}_{ma x} = {e}^{- {( \frac{4 π σ}{λ} )}^{3}} . \qquad ( 10 )$$

For high reflectivities it is therefore desirable to be able to fabricate the concave surface with minimal roughness. Advantageously, the mirrors 11 and 12 have a root-mean-square roughness of at most 1 nm.

Other losses can be experienced due to edge effects if the concave mirror deviates from the ideal shape within the spatial extent of the mode.

The mirrors 11 and 12 have a reflectance of at least 99%, preferably at least 99.5%, but the reflectivity of such Bragg reflectors on substrates 15 and 16 of suitable material can reach 99.9999%, whereupon it generally becomes limited by trace absorption in the dielectric materials. Use of such relatively high reflectivities increase the quality factor Q.

In view of the above construction, the optical cavity 13 may be provided with a configuration providing small mode volumes and high quality factors Q. Therefore it is possible to provide the optical cavity with effectively a single mode within a wavelength band of interest.

The mirror 11 may be manufactured as follows.

The mirror 11 may be made using an etching technique to produce concave surfaces in silicon and thereby to fabricate cavities for single atom detection as disclosed in References [1] and [2] (that are incorporated herein by reference) (the References being cited at the end this description).

The mirror 11 may be formed by depositing mirrors onto convex surfaces such as silicon microlenses and then transfer them onto fibre tips using a lift-off technique as disclosed in Reference [3] (that is incorporated herein by reference).

The mirror 11 may be formed by using a bubble trapping method in glass to produce highly spherical surfaces with radii of curvature of order 50 μm, as disclosed in Reference [4] (that is incorporated herein by reference).

The mirror 11 may be formed by optical ablation of silica using a CO₂ laser, which has been demonstrated to be capable of providing Q factors of order 10⁶, and mode volumes as small as 2 μm³, as disclosed in Reference [5] (that is incorporated herein by reference).

The preferred method to form the mirror 11 is to use focussed ion beam milling. For example, it is possible to apply the technique disclosed in Reference [6] (that is incorporated herein by reference). In this example, a gallium beam of current 5 nA and acceleration voltage 30 kV is rastered over a planar substrate, modulating the dwell time between 0.1 ms and 50 ms at each point to produce the desired features. The advantage of this method is that control over the shape of the concave surface is achievable at the nanometre length scale, whilst retaining sub nanometre roughness. In this way concave features of any desired radius of curvature down to about 100 nm, or possibly less, can be achieved, and coated with high reflectivity mirrors. It should be noted that mirrors in the form of high reflectivity Bragg reflectors are typically a few micrometres thick, which may place a limitation on the minimum size of concave feature that would be preserved after coating. Nevertheless significant reductions in mode volume are possible using this technique, as compared to the other techniques mentioned above.

So far using this technique, the inventors have achieved mode volumes as small as 0.5 μm³, corresponding to ˜6λ³, at an operating wavelength of 440 nm in a 1.44 refractive index fluid, using a cavity with β=7 μm and L=1.6 μm. This mode volume has combined with a Q factor of 1000, and Q factors of up to 18,000 have been achieved using larger cavities.

The optical cavity 13 formed by a convex mirror 11 and a planar mirror 12 is advantageous in that the use of the planar mirror 12 avoids the need to provide alignment of the mirrors 11 and 12 perpendicular to the optical axis O between the mirrors 11 and 12. However, the mirrors 11 and 12 may have alternative shapes to provide an optical cavity. In general terms, the mirrors may each be curved with respective radii of curvature β and γ (where a planar mirror has an infinite radius of curvature, provided that in order to provide stable resonances, the mirrors 11 and 12 meet the requirement that 0≦(1−(L/β)).(1−(L/γ))≦1. Further details of alternative forms of the optical cavity 13 are given in Reference [7] (that is incorporated herein by reference).

To provide tuning of the wavelength of the modes of the optical cavity 30, the apparatus 1 is further provided with an actuator system 20 that is arranged to move the mirrors 11 and 12 relative to each other along the length of the optical cavity 13 between the mirrors 11 and 12. In particular, the actuator system 20 comprises a piezoelectric actuator 21 that is arranged between the mirrors 11 and 12 with extension parallel to the optical axis O. One of the mirrors 11 is mounted directly on a support 22 and the other mirror 12 is mounted on the support 22 by the piezoelectric actuator 21, although other constructions for mounting the piezoelectric actuator 21 between the mirrors 11 and 12 are possible. The piezoelectric actuator 21 is driven by a drive signal supplied from a drive circuit 23 to provide positional control.

The mode structure of the optical cavity 13 can be characterised by measuring the optical transmission spectrum for broad band incident EM radiation. By way of example, FIG. 6 shows some typical transmission spectra derived from an optical cavity 13 made by the technique disclosed in Reference [6], illustrating the tunability, quality factor, and Hermite Gauss mode structure. FIG. 6(a) shows the transmission spectra for two cavities each with β=7 μm at L=3.0 μm and L=12.3 μm, respectively. This shows how the FSR increases as L is reduced. FIG. 6 (b) is a close-up of the Hermite-Gauss mode structure from a single longitudinal mode. TEM₀₀ is at 655 nm, TEM₀₁ and TEM₁₀ are at 649 nm, etc. FIG. 6 (b) shows a splitting observed between with TEM₀₁ and TEM₁₀ resulting from a slight deviation from cylindrical symmetry. FIG. 6 (c) shows a high Q longitudinal resonance (scatter) with Lorentzian curve fit (solid line). The resolution of the spectrograph used for the measurements is about 0.05 nm, contributing substantially to the line width observed.

As EM radiation is passed through the optical cavity 13 in a direction along the optical axis O between the mirrors 11 and 12, the cavity arrangement 10 constitutes an optical filter that bandpass filters incident EM radiation passing therethrough with a filter characteristic that matches the intensity characteristics of the optical cavity 13, so that the passbands have the positions and widths in wavelength of the modes of the cavity. The cavity 13 is arranged to have at least one mode, preferably a single mode, which is more preferably a TEM₀₀ mode, within the band of wavelengths emitted by the EM source 2, for example as illustrated schematically by graph (b) in FIG. 1. The optical cavity 13 is designed for the mode to be in the wavelength range of interest for the spectroscopy being performed. The line width of the filter is equal to the absolute wavelength λ divided by the quality factor Q, and this determines the maximum resolution of the spectroscopic technique.

Wavelength tuning of the filter characteristic, in particular of the wavelength of the passband(s), is achieved by controlling the cavity length L using the actuator system 20.

For optimum filtering, the cavity arrangement 10 is configured so that transmission will only occur through a single mode of the optical cavity 13, most likely a TEM₀₀ mode. Each mode is Lorenzian in line shape, following the equation

$$T = \frac{{T}_{ma x}}{{( ω - {ω}_{0} )}^{3} + {κ}^{3}} \qquad ( 11 )$$

where Tₘₐₓ is the peak transmission intensity ω=2πc/λ is the angular frequency of the EM radiation, ω₀ is the resonant frequency, and κ is the photon leakage rate which is equal to the half-width of the transmission peak, also referred to as η above. Values of κ as small as 100 MHz may be achieved with existing mirror coating technology.

The design of the optical cavity 13 as discussed above provides for ultra-high resolution spectroscopy, for example in some embodiments allowing a combination of a Q factor of 10⁶ with a tuning range of order 0.1λ to provide up to 10⁵ frequency points. The peak transmission approaches unity if the reflectivities of the mirrors 11 and 12 are matched and intracavity losses are negligible. Equation (14) also describes the extinction of EM radiation outside the ‘transmission band’: for example at ω−ω₀=3κ the extinction is 10 dB, and at ω−ω₀=10κ it is 20 dB, etc.

FIG. 7 shows an example transmission spectrum for the optical cavity 13 with β=25 μm, and L=3.2 μm. The spectrum is plotted on log-linear axes to enable the off-resonant extinction to be viewed over the full range of wavelengths. Lorentzian line shapes are fitted to the measured spectrum, six peaks in all corresponding to the six Hermite-Gauss modes within the measured spectral range. The peak labelled (10,0,0) at 642 nm is due to transmission through a TEM₀₀ mode with ten longitudinal nodes. The transmission line full-width-at-half-maximum is about 0.1 nm, and provides about 80% of the total transmitted intensity within the 25 nm spectral range of the measurement.

The spectrum in FIG. 7 reveals transmission through additional TEM modes at shorter wavelength. These may be tolerable for some applications, but if necessary can be minimised or eliminated by one of three methods (or a combination thereof): (i) reducing β to increase the separation between the TEM modes, (ii) reducing the numerical aperture of the input/output coupling, since the TEM₀₀ mode is strongest at normal incidence, (iii) utilising an additional, broader band pass tunable filter in series to further suppress transmission of EM radiation far from the TEM₀₀ peak.

In the example shown in FIG. 1, the cavity arrangement 10 is disposed between the EM source 2 and the sample holder 3, so that the EM radiation is filtered before being incident on the sample 4. Thus the sample 4 only receives EM radiation in the passbands. This simplifies conceptualisation of the spectroscopy in that only the interaction of the passed wavelengths needs to be considered. However, alternatively the cavity arrangement 10 may be disposed elsewhere in the optical path between the EM source 2 and the detector 5, for example between the sample holder 3 and the detector 5 so that the EM radiation is filtered after being incident on the sample 4. In that case, the interaction occurs at all wavelengths, but in most applications where there is no wavelength conversion in the sample 4 that provides no difference in operation because the detector 5 receives the same signal in each case.

The cavity arrangement 10 may be used as an optical filter in a number of practical spectroscopy applications, some examples of which are as follows.

One example is for optical absorption spectroscopy of gases or liquids. In this example, the sample 4 is a gas or liquid and the transmission of the EM radiation therethrough is measured. The sweeping of the filter wavelength whilst monitoring the optical power transmitted allows an absorption spectrum to be generated. The measured absorption spectrum may then be used to identify the composition of the sample.

Infrared spectroscopy is a simple and reliable technique widely used in both organic and inorganic chemistry, in research and industry. It is used in quality control, dynamic measurement, and monitoring applications such as the long-term unattended measurement of CO₂ concentrations in greenhouses and growth chambers by infrared gas analyzers. It includes rotational and vibrational spectroscopy of gases and fluids and gas and liquid phase sensing

Optical spectroscopy of liquids and gases is widely used to identify the constituent atoms and molecules by their characteristic optical absorption spectra. Optical transitions occur between two energy eigenstates of the molecule. The strongest transitions are those which are ‘electric dipole allowed’ transitions, and which follow the angular momentum selection rules. These can occur at a range of wavelengths, from deep ultraviolet to the mid infrared depending on the molecule and the transition in question. Often a molecule will exhibit a family of transitions (fine structure) close together in wavelength, resulting from its characteristic vibrational and rotational states. These rotational-vibrational (‘rovibrational’) spectra can serve as a unique signature of a molecular species, and so are useful as a means to detect the presence of target molecules in a sample. The need to resolve spectrally the rovibrational energy levels places quite demanding constraints on the measurement apparatus. Rotational energy levels are typically separated by ˜10⁻²³ J, or 100 μeV (20 GHz), placing a lower limit on the resolution required to resolve these lines, and the spectral range is typically of order a few hundred meV.

By way of an example, FIG. 8 shows the rovibrational absorption spectrum of methane calculated by theory in the bottom plot and the rovibrational spectrum measured by optical absorption spectroscopy in the top plot. It can be seen that the absorption spectrum occurs at a mid-infrared wavelength of about 3 μm, and can be well characterised.

In the visible region of the spectrum the highest quality factor Q will be achieved using dielectric Bragg reflectors as the mirrors 11 and 12, as their absorption losses can be as low as a few parts per million, thus producing Q factors as large as 10⁶. In the near infrared the mirrors 11 and 12 can be either dielectric mirrors or metallic mirrors, the latter providing broader reflection band widths at the cost of slightly lower maximum Q factors of the order of 10³. It is noted that a quality factor Q of 10³ would provide a spectral resolution of the order of 3 cm⁻¹ for the spectrum in FIG. 8, sufficient to resolve the individual rovibrational transitions.

Current apparatuses for performing rovibrational spectroscopy require either an expensive tunable laser or an expensive spectrometer such as a Fourier Transform Infrared (FTIR) spectrometer to achieve the spectral resolution. The apparatus 1 removes the need for either of those devices by using the cavity arrangement 10 as a means for spectral discrimination being a simple, inexpensive package.

The apparatus 1 may be modified so that the cavity arrangement 10 provides an array of optical cavities 13, each of which acts as an optical filter. This may be achieved by changing the shape the mirror 11 to be an array of concave mirrors, each of which acts with the planar mirror 12 to provide an optical cavity 13. The mirror 11 may be manufactured by the same techniques as described above. By way of example, FIG. 9 shows an electron micrograph of an array of concave substrates manufactured using the technique described in Reference [6] and suitable for mirror coating to form the mirrors.

Where such an array of optical cavities is provided, the actuator system 20 may be arranged to move the mirrors of each optical filter together, that is simultaneously and in a correlated fashion. This may be achieved, for example, by moving the entire mirror 11. In that case, the wavelengths of the modes of each cavity 13 are tuned together, for example to a common value or to another distribution of values determined by the fabrication and alignment of the mirror arrays. This allows the apparatus 1 to perform spectroscopy with spatial variation, to provide spatial imaging.

Where such an array of optical cavities is provided, the actuator system 20 may be alternatively arranged to move the mirrors of each optical filter independently for example by splitting the mirror 11 into portions adjacent each concave mirror and moving each independently. In that case, the wavelengths of the modes of each cavity 13 may be tuned independently to any desired value within the tuning range, which may be different for different cavities 13.

This allows the apparatus 1 to perform spectroscopy with spectral variation, to provide spectral imaging.

These techniques may be combined to provide both spatial and spectral imaging, for example by recording successive images whilst sweeping the transmission wavelength.

Using such techniques, the apparatus may be applied to a range of imaging spectroscopy techniques (multispectral imaging, hyperspectral imaging, full spectral imaging) In this case the EM source 2 may be either a dedicated source used to illuminate the scene being imaged, or may be another ambient source of EM radiation. Imaging spectroscopy is most commonly used in forensic sciences, remote sensing, and surveillance.

By providing a means to fabricate large regular arrays of tunable filters it facilitates imaging spectroscopy using a single camera chip and simple focusing optics. In principal an existing imaging system could be adapted for hyperspectral functionality. The microcavity arrays provide narrow line widths that are robust to slight loss of parallelism between the mirrors, and which can accommodate a larger range of incident angles than can conventional planar Fabry Perot designs.

### REFERENCES

[1] M. Trupke, E. A. Hinds, S. Eriksson, E. A. Curtis, Z. Moktadir, E. Kukharenka, and M. Kraft, Appl Phys Lett 89, 211106 (2005)
[2] M. Trupke, J. Goldwin, B. Darquie, G. Dutier, S. Eriksson, J. Ashmore, and E. A. Hinds, Phys Rev Lett 99, 063601 (2007)
[3] T. Steinmetz, Y. Colombe, D. Hunger, T. W. Hansch, A. Balocchi, R. J. Warburton, and J. Reichel, Appl Phys Lett 89, 111110 (2006)
[4] G. Cui, J. M. Hannigan, R. Loeckenhoff, F. M. Matinaga, M. G. Raymer, S. Bhongale, M. Holland, S. Mosor, S. Chatterjee, H. M. Gibbs, and G. Khitrova, Optics Express 14, 2291 (2006)
[5] D Hunger et al, NJP 12, 065038 (2010)
[6] Dolan et al., “Femtoliter tunable optical cavity arrays”, Optics Letters, Vol. 35, No. 21, November 2010
[7] K Vahala Nature 424, p 839 (2003).

1. A method of filtering EM radiation in an apparatus for performing spectroscopy that comprises, arranged along an optical axis:
an EM source arranged to generate EM radiation having a band of wavelengths for illuminating a sample;
a sample holder arranged to hold the sample; and
a detector for detecting EM radiation transmitted through the sample,
the method comprising:
providing, within the apparatus between the EM source and the detector, an optical filter comprising a pair of mirrors opposed along the optical axis and shaped to provide an optical cavity with stable resonance and having a cavity length of at most 50 μm and a mode at a wavelength within said band of wavelengths for bandpass filtering EM radiation passing therethrough, and
further providing an actuator system arranged to move the mirrors relative to each other along the length of the optical cavity for tuning the wavelength of said mode.

2. The method according to claim 1, wherein said mode is confined perpendicular to the optical axis between the mirrors.

3. The method according to claim 1, wherein at least one of the mirrors is concave.

4. The method according to claim 3, wherein said at least one of the mirrors that is concave has a radius of curvature of at most 50 μm, preferably at most 30 μm or 10 μm.

5. The method according to claim 3, wherein the mirrors have respective radii of curvature β and γ meeting the requirement that 0≦(1−(L/β)).(1−(L/γ))≦1.

6. The method according to claim 3, wherein one of the mirrors is concave and the other one of the mirrors is planar.

7. The method according to claim 1, wherein the at least one of the mirrors that is concave is formed by focussed ion beam milling.

8. The method according to claim 1, wherein, within said band of frequencies, the optical cavity has a single mode.

9. The method according to claim 1, wherein the cavity length is at most 30 μm, preferably at most 10 μm.

10. The method according to claim 1, wherein the optical filter is provided between the EM source and the sample holder for filtering the EM radiation generated by the EM source before illumination of the sample.

11. The method according to claim 1, wherein said mode is a fundamental transverse mode of the optical cavity.

12. The method according to claim 1, wherein the sample holder is a container for a gas or liquid sample.

13. The method according to claim 1, further comprising providing, within the apparatus between the EM source and the detector, an array of said optical filters.

14. The method according to claim 13, further comprising using the actuator system to move the mirrors of each optical filter together so as to tune the wavelengths of said modes of the optical cavities of the optical filters together.

15. The method according to claim 13, further comprising using the actuator system to move the mirrors of each optical filter independently so as to tune the wavelengths of said modes of the optical cavities of the optical filters independently.

16. The method according to claim 1, wherein the mirrors have a root-mean-square roughness of at most 1 nm.

17. The method according to claim 1, wherein the mirrors have a reflectance of at least 99%, preferably at least 99.5%.

18. The method according claim 1, wherein the mirrors are Bragg reflectors.

19. The method according to claim 1, wherein the actuation system comprises a piezoelectric actuator.

20. An apparatus for performing spectroscopy comprising, arranged along an optical axis:
an EM source arranged to generate EM radiation having a band of wavelengths for illuminating a sample;
a sample holder arranged to hold the sample; and
a detector for detecting EM radiation transmitted through the sample,
the apparatus further comprising:
between the EM source and the detector, an optical filter comprising a pair of mirrors opposed along the optical axis and shaped to provide an optical cavity with stable resonance and having a cavity length of at most 50 μm and a mode at a wavelength within said band of wavelengths for bandpass filtering EM radiation passing therethrough; and
an actuator system arranged to move the mirrors relative to each other along the length of the optical cavity for tuning the wavelength of said mode.
